(19) United States
(12) Patent Application Publication
(10) Pub. No.: US 2017/0299157 A1
(43) Pub. Date: Oct. 19, 2017

(54) Light Bulb Changer

(71) Applicants: Marshall Stauber, Hollywood, FL (US); Justin Stauber, Hollywood, FL (US)

(72) Inventors: Marshall Stauber, Hollywood, FL (US); Justin Stauber, Hollywood, FL (US)

(21) Appl. No.: 15/099,520

(22) Filed: Apr. 14, 2016

(51) Int. Cl. F21V 19/04; B25G 1/04

(52) U.S. Cl. CPC F21V 19/04; B25G 1/04

(57) ABSTRACT

The invention is an apparatus for connecting and disconnecting light bulbs including a suction cup and at least one structure for interrupting suction to the suction cup.

### BACKGROUND OF THE INVENTION

It is often difficult to change light bulbs where the sockets are significantly above the level of the floor. Although some people use ladders, sometimes the ladders still are insufficient for reaching certain bulbs. Extenders exist, but they are often cumbersome and are difficult to use when dealing with angularly positioned light sockets. The present invention addresses this by providing a suction cup operatively associated with an electromechanical device for grasping a light bulb and subsequently releasing the light bulb.

### SUMMARY OF THE INVENTION

The present invention uses a pneumatic solenoid valve coupled with a suction cup to grasp and release the surface of a light bulb in the suction cup utilizing air pressure differential.

In one embodiment, an electric solenoid valve is used in conjunction with a suction cup, whereby applying voltage can either open the valve and let air in releasing suction or it can be open until current applied and than it closes it.

In one embodiment, the valve is controlled with a push button that actuates a momentary electrical current that is applied thereby releasing the suction. When the button is not pushed no energy is expanded to keep valve closed, and therefore battery last a long time.

In one embodiment, an additional vacuum is used to allow ease of attachment.

In addition the suction cups configured in the present invention have small nubs about the perimeter. This prevents hover effect which prevent cup from slipping and allows for placement of cup on center of bulb for better attachment. Without this cup slides off to side and final placement on bulb is eccentric, making its dislodgment more likely.

In one embodiment, the Invention utilizes the suction for ease of attachment. The system and method of the invention includes attaching coiled wire to transmit current and allows telescoping of pole. Without this technique undo pressure on electrical connection at top and bottom would result in failure.

In one embodiment the present invention is an apparatus for connecting and disconnecting light bulbs, said apparatus comprising:
a suction cup having a mounting surface;
a suction cup support having an angularly flared surface adjacent to and in the direction of said suction cup; and
at least one structure constructed and arranged to introduce air to said mounting surface.

In one embodiment, the structure constructed and arranged to introduce air to said mounting surface is a release tab.

In one embodiment, the structure constructed and arranged to introduce air to said mounting surface is an air channel operatively associated with a solenoid valve.

In one embodiment, the solenoid valve is a mechanical, non-electric valve.

In one embodiment, the solenoid valve is an electric valve.

In one embodiment, the valve is actuated by an actuator with direct hard-wired connection.

In one embodiment, the valve is actuated by an actuator with a wireless connection.

In one embodiment, the cup support is constructed and arranges as two congruent half circles that snap fit into a support base.

In one embodiment, the apparatus further comprises a support pole.

In one embodiment, the support pole is constructed and arranged as a telescoping pole.

In one embodiment, the angular flare is between about 5-20 degrees.

Also contemplated is a method of installing a light bulb, said method comprising the steps of:
providing an apparatus according to the present invention;
providing a light bulb to be installed in a light bulb socket;
positioning said light bulb onto said mounting surface;
applying pressure from said light bulb in a direction of said mounting surface;
imparting suction upon said light bulb from said applying of pressure;
positioning said light bulb for installation into said light bulb socket;
rotating said assembly in a manner such that said light bulb mates with said light bulb socket; and
introducing air to said suction cup mounting surface by activating said structure constructed and arranged to introduce air to said mounting surface.

In one embodiment, the method further comprises providing said suction cup with at least one release tab positioned along a perimeter edge.

In one embodiment, the method further comprises applying pressure on said release tab in a direction away from said light bulb.

In one embodiment, the method further comprises providing a solenoid valve and an air delivery channel, whereby said air delivery channel is configured to deliver air to said mounting surface.

In one embodiment, the method further comprises said solenoid valve is a mechanical non-electric valve.

In one embodiment, the method further comprises solenoid valve is an electric valve.

### BRIEF DESCRIPTION OF THE SEVERAL VIEWS OF THE DRAWING

FIG. 1 is an exploded perspective view of components according to one embodiment of the present invention.

FIG. 2A is a separated perspective view of the solenoid and suction cup assembly with one embodiment of the present invention.

FIG. 2B is demonstrative of lightbulb placement in a suction cup assembly according to one embodiment of the present invention.

FIG. 3 is a side partial cross-section view of the solenoid and suction cup assembly according to one embodiment of the present invention.

FIG. 4 is a side partial cross-section view of the solenoid and suction cup assembly according to one embodiment of the present invention whereby the solenoid is in an open position.

FIG. 5 is a side partial cross-section view of the solenoid of FIG. 2B along section line A-A.

FIG. 6 is a side partial cross-section view demonstrative of the suction cup in a non-aligned position.

FIG. 7 is a separated perspective view demonstrative of a pole and support sub assembly according to one embodiment of the present invention.

FIG. 8 is demonstrative of placement of connected components from FIG. 7.

FIG. 9 demonstrates placement of power supply in the poll according to one embodiment of the present invention.

FIG. 10A is an end view of the current seal inner support according to one embodiment of the present invention.

FIG. 10 B is a side partial cross-section view of the cup seal inner support according to one embodiment of the present invention.

FIG. 11 A is a side partial cross-section view of the spacer clamp “C” configuration according to one embodiment of the present invention.

FIG. 11 B is an end view of a spacer clamp “C” configuration according to one embodiment of the present invention.

FIG. 11 C is a side partial cross-section view of the spacer clamp “semicircle” configuration according to one embodiment of the present invention.

FIG. 11 D is an end view of a spacer clamp “semicircle” configuration according to one embodiment of the present invention.

FIG. 12 A is an end view of a suction cup with one embodiment of the present invention.

FIG. 12 B is a side view of a suction cup according to one embodiment of the present invention.

FIG. 13 A is an end view of a suction cup point to one embodiment of the present invention showing placement of a release tab.

FIG. 13 B is a side view of a suction cup of corn to one embodiment of the present invention demonstrating placement of a release tab.

FIG. 14 A is a side view of a suction cup according to the present invention showing indents.

FIG. 14 B is an end view of a suction cup according to the present invention showing indents.

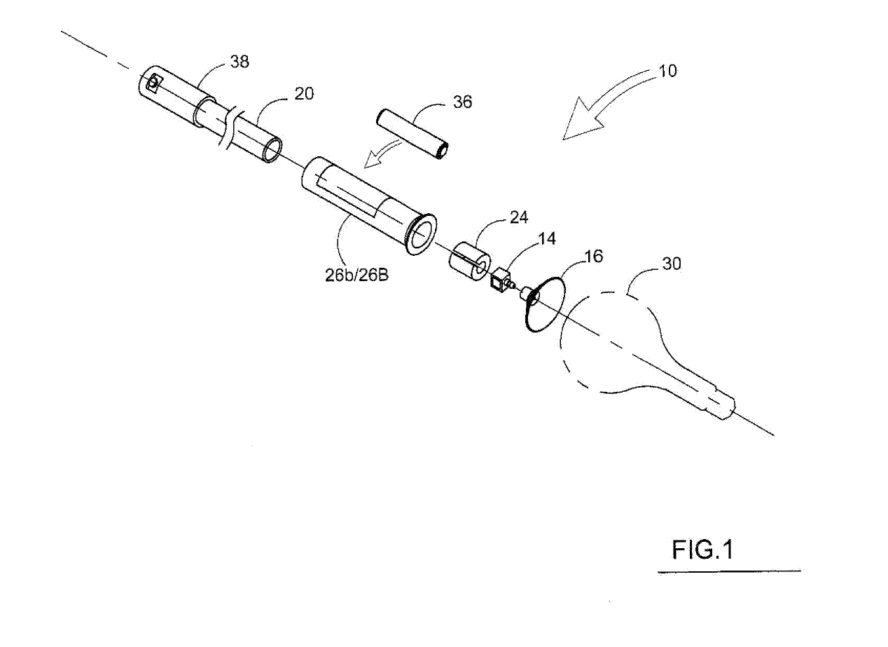

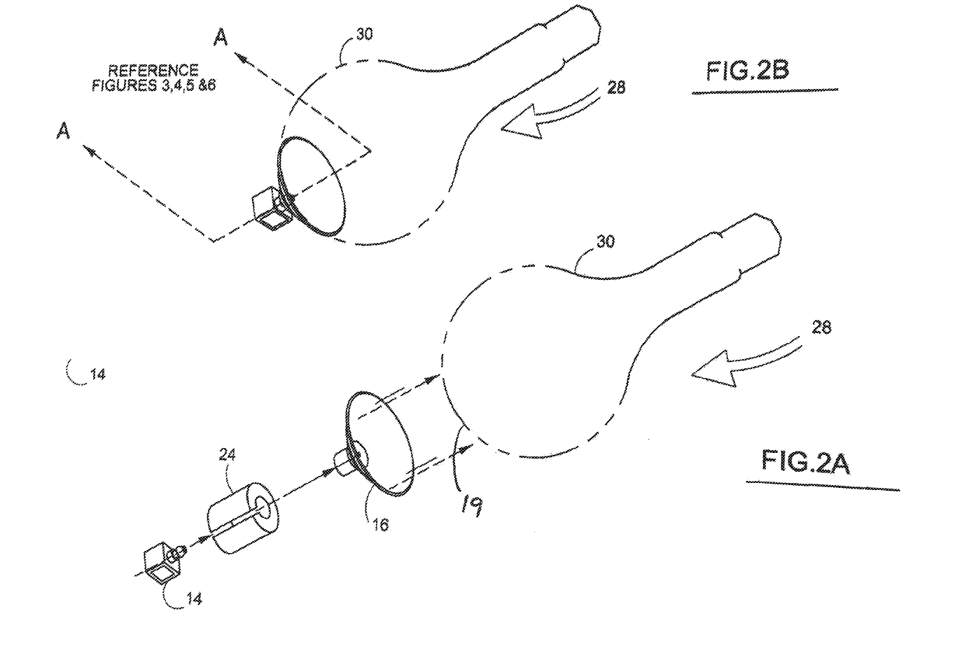

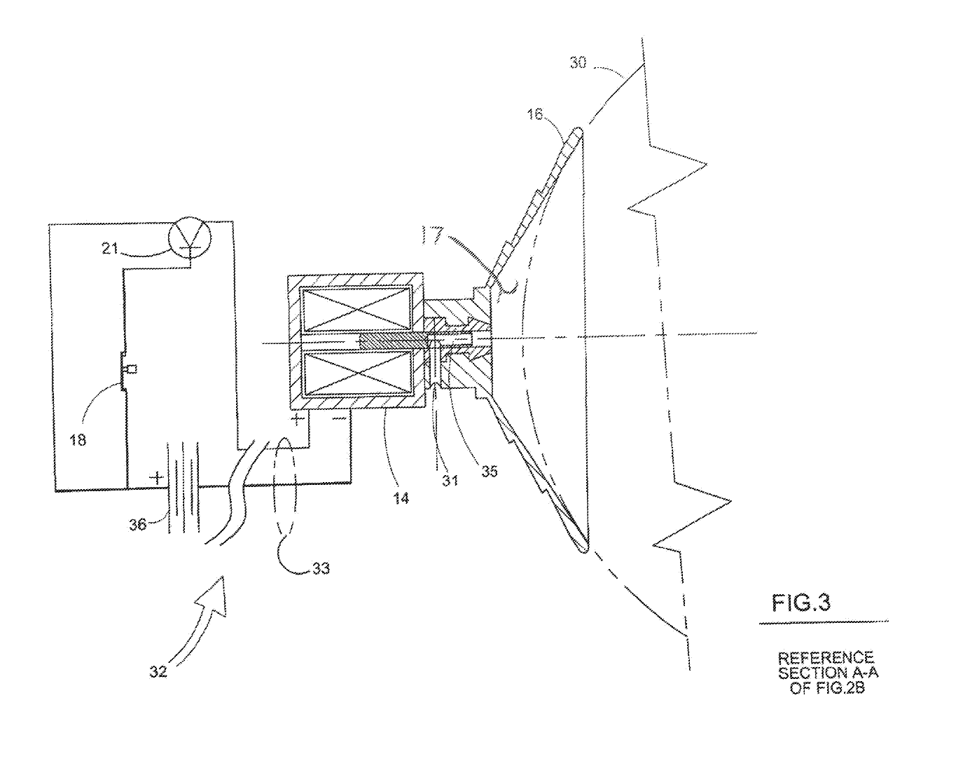

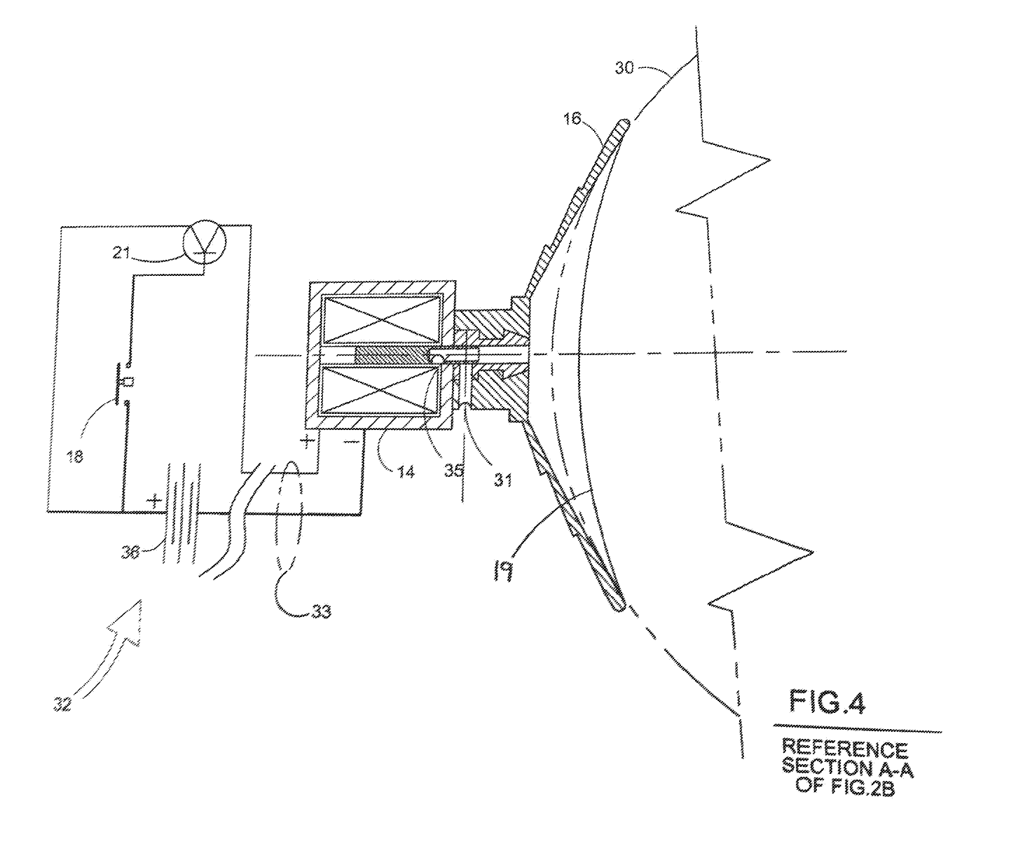

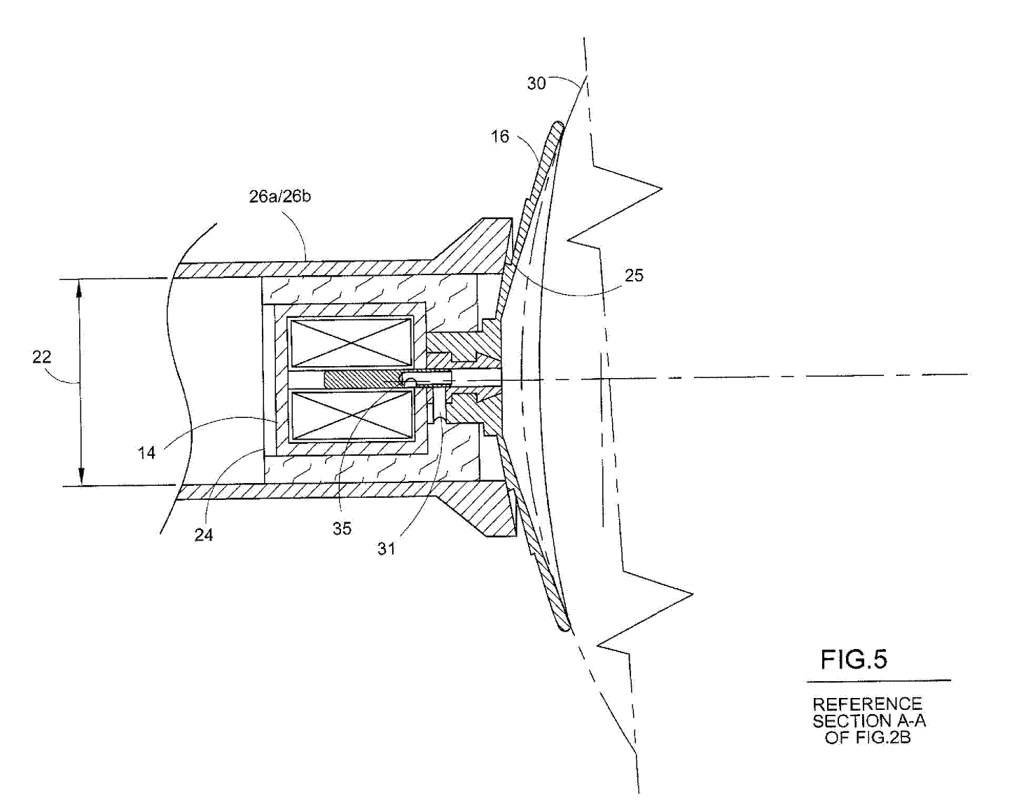

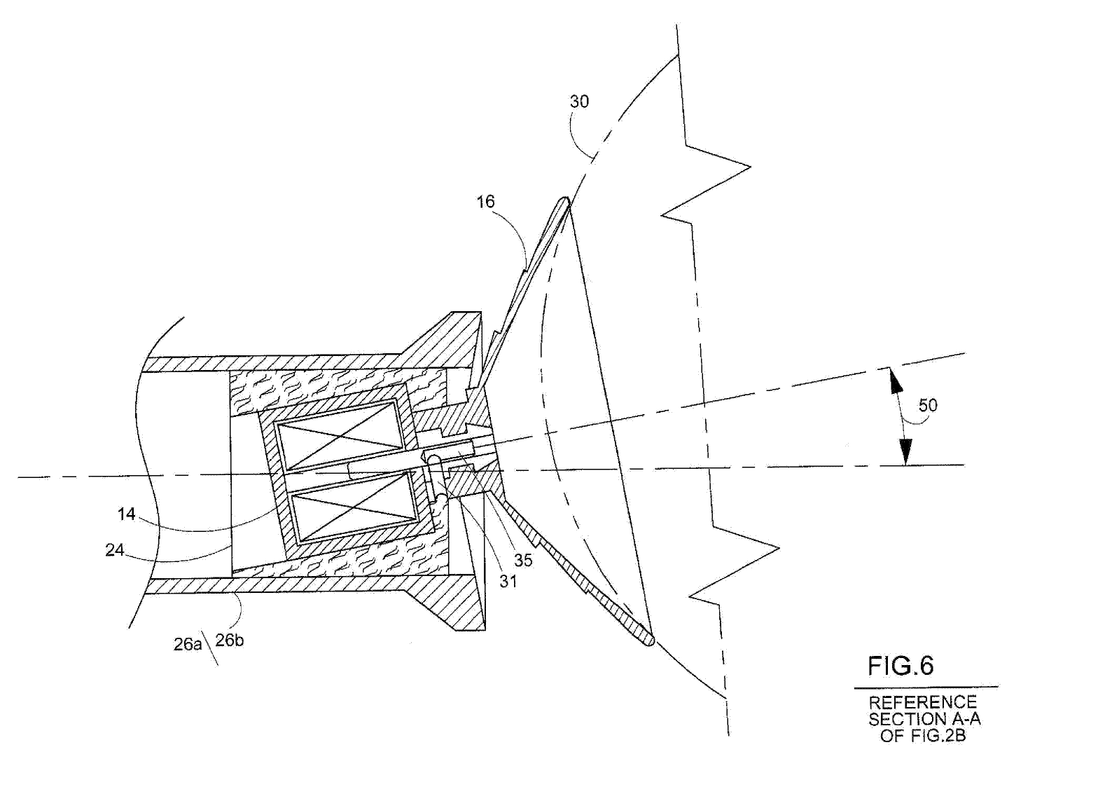

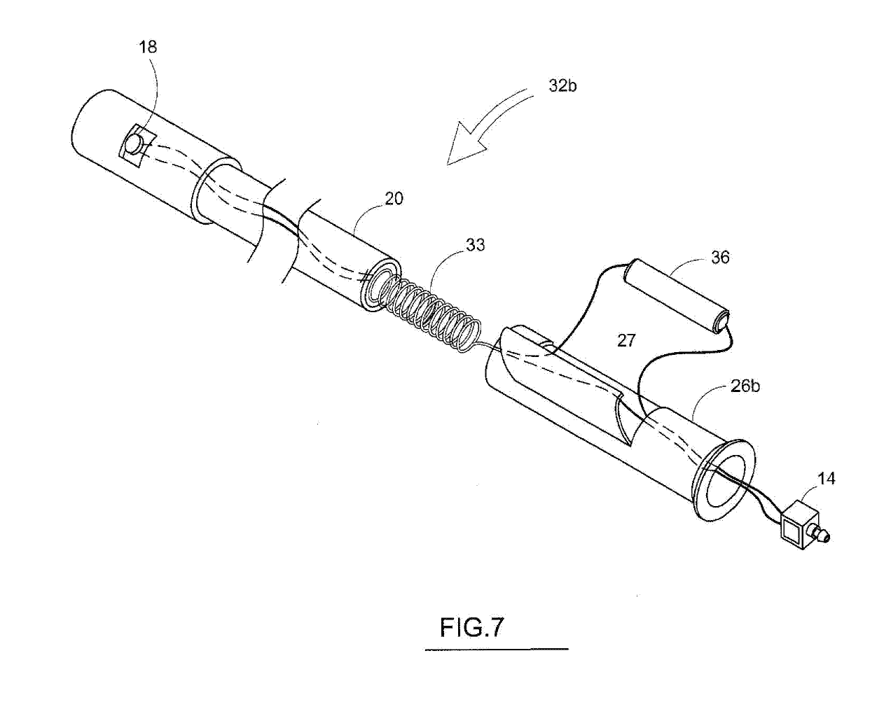

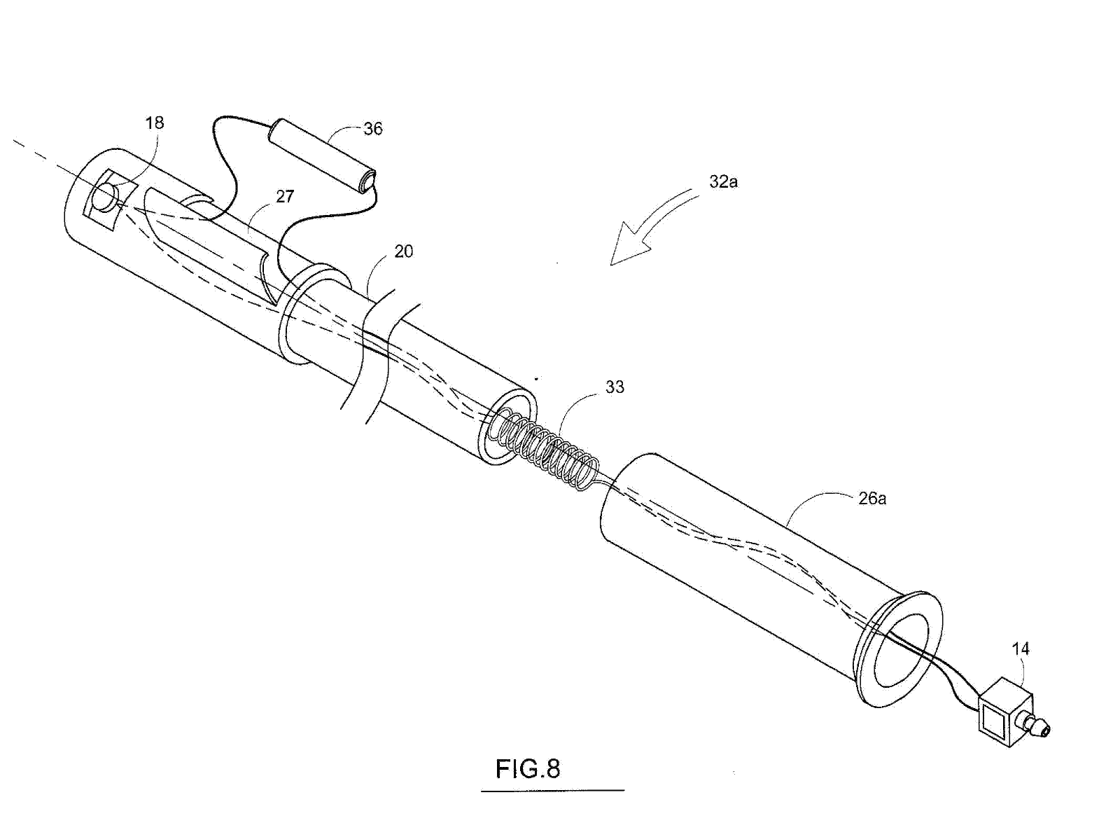

### DETAILED DESCRIPTION OF THE PREFERRED EMBODIMENT

The present invention relates generally to a device for reaching light bulbs that are beyond the normal reach of most persons.

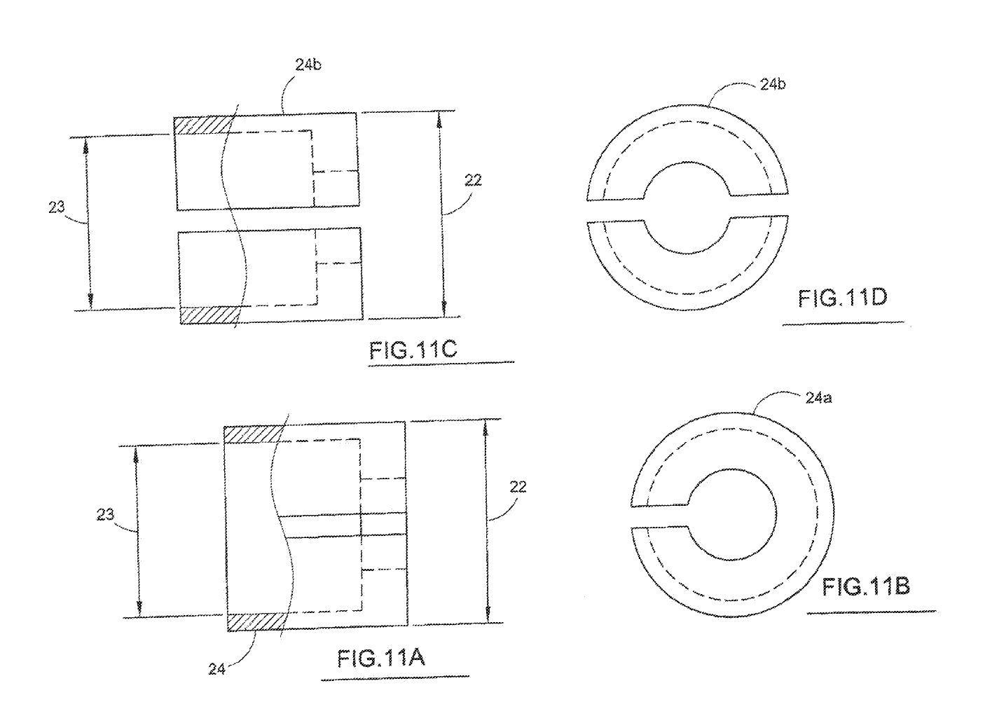

As generally understood, assembly 10 is constructed and arranged for supporting light bulb 30. Suction cup 16 is dependent upon clamp 24. When light bulb 30 is affixed to suction cup 16, suction cup cavity 17 (not necessarily drawn to scale) is a small cavity or void that is operatively associated, as will be described below, with structure to direct air into suction cap cavity 17 as desired and thus release light bulb 30 from suction cup 16. Cavity 17 envelopes the part of light bulb 30 inserted into suction cup 16 that is light bulb mounting surface 19, which is understood to be only that part of the light bulb surface defined by placement within the perimeter of suction cup 16. In one embodiment, spacer clamp 24 as best seen in FIG. 11 B is in a “C-shape” configuration as shown. Positioned adjacent to suction cup 16 and clamp 24 is solenoid valve 14. Pole 20 is constructed and arranged to incorporate therewith a cup seal inner support whereby said cup where is configured either as where no power supply is incorporated therein 26A or cup whereby a power supply 36 is incorporated therein.

In one embodiment, transistor 21 is utilized in the electrical components to account for wire length.

Pole 20 supports suction cup 16 on a first end and handle 38 on a second end.

Solenoid suction cup assembly 28 includes in one embodiment a power source 36 with power actuator 18 whereby power cord 33 the levers of electricity from power control subassembly 32 to solenoid valve 14. First orifice 35 provides for an inner passage from solenoid valve 14 to cavity 17 of suction cup 16 and second orifice 31 provides for an exhaust air passage from the assembly. Angle 50 demonstrates acute angular offset of suction cup 16 from a central axis of assembly 10. In one embodiment, an internal power cord 33 provides for actuation of power source 36 to solenoid 14 when actuator 18 is activated.

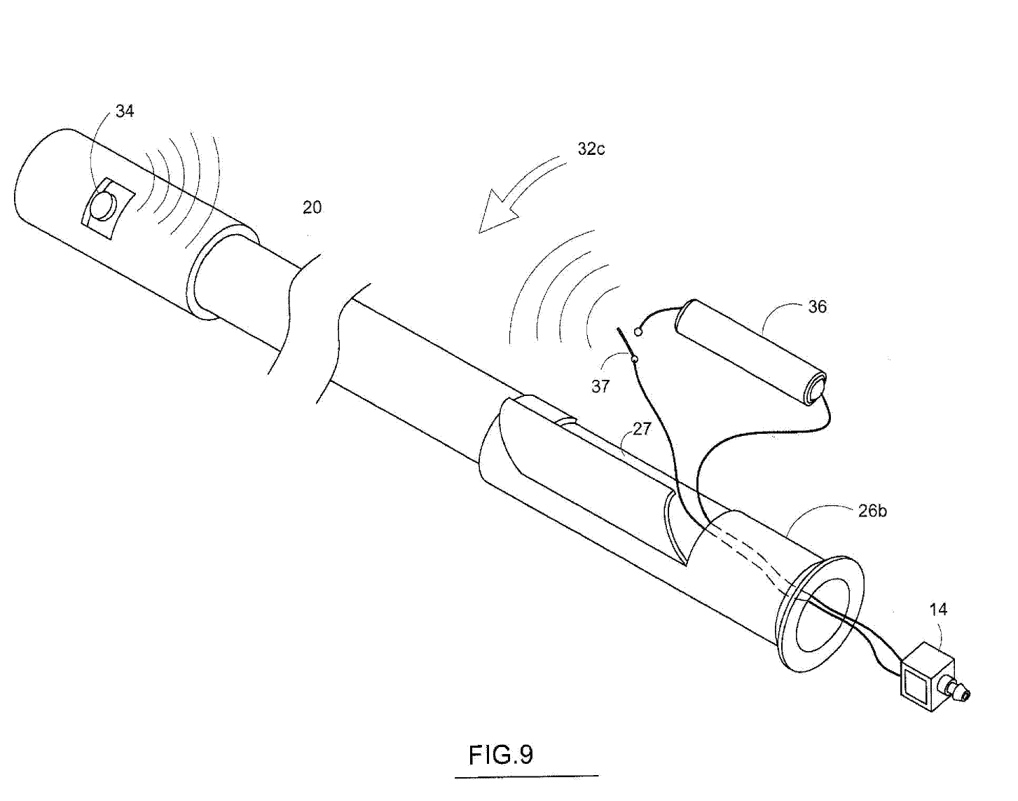

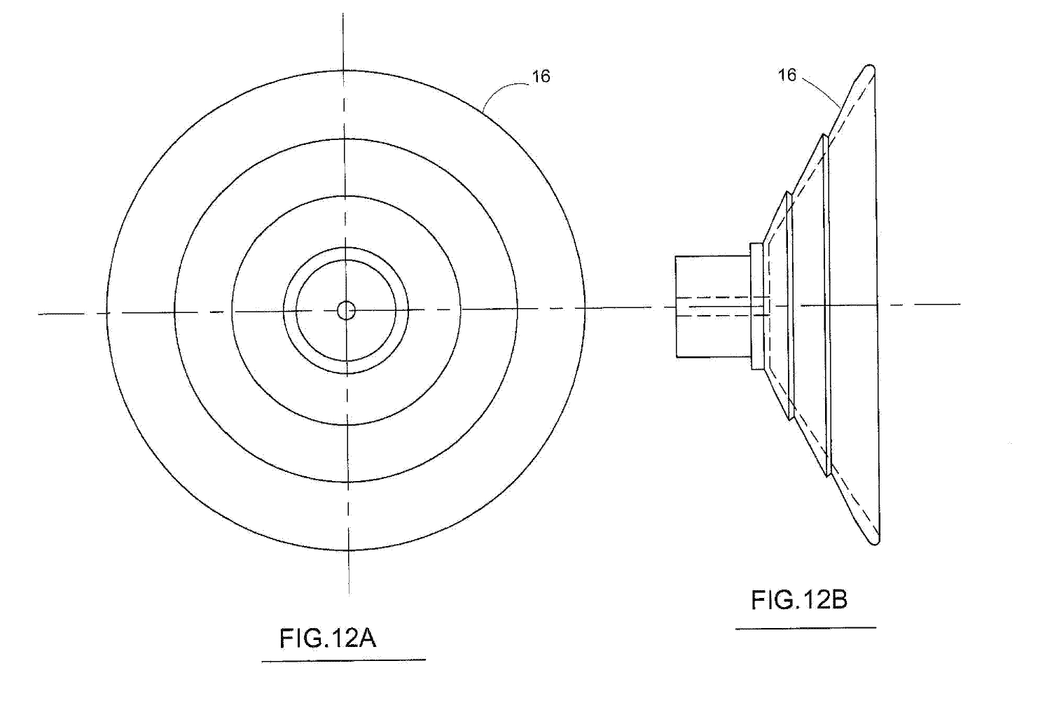

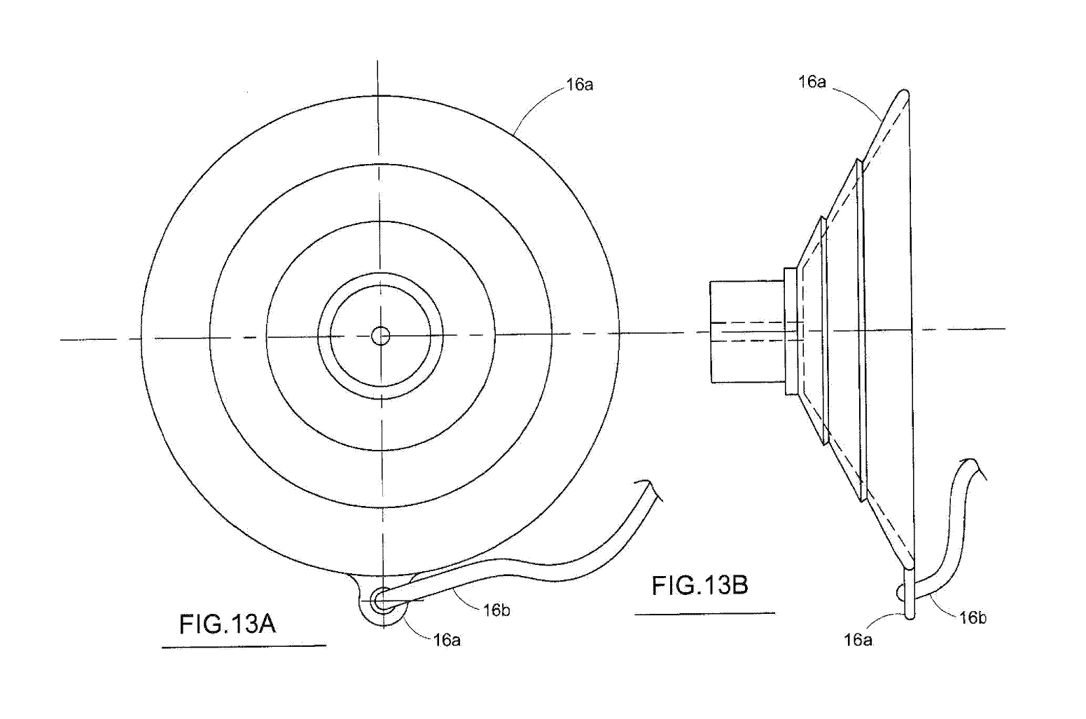

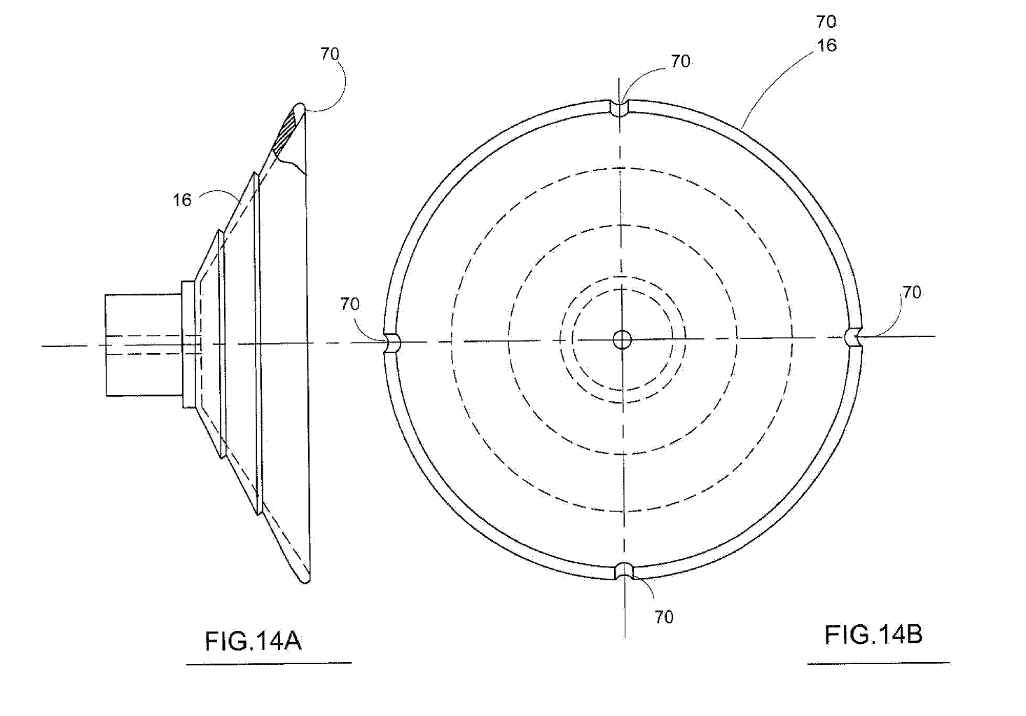

In another embodiment, as demonstrated in FIG. 9, wireless where 34 transmits a wireless signal to wireless switch 37 that initiates and ceases power to solenoid 14. In one embodiment as demonstrated in FIGS. 12 A and 12 B suction cup 16 is presented as shown. In another embodiment as demonstrated in FIGS. 13 A and 13 B release tab 16 a is constructed and arranged along the perimeter of suction cup 16 whereby release tab 16 a is configured to receive a release line whereby section is interrupted and light bulb 30 is released once positioned. In an embodiment demonstrated in FIGS. 14 A and 14 B, a plurality of nodes 70 is positioned about the perimeter of suction cup 16. Nodes 70 assist by releasing suction and subsequently releasing attachment a light bulb 30 from suction cup 16.

In one embodiment, as demonstrated in the FIGS. 11A and 11B spacer clamp 24 is provided in a “C-shaped” configuration. In another embodiment, as in FIGS. 11C and 11D clamp 24 is provided as to complementary semicircles constructed and arranged to snug fit into either cup support 26A and 26B.

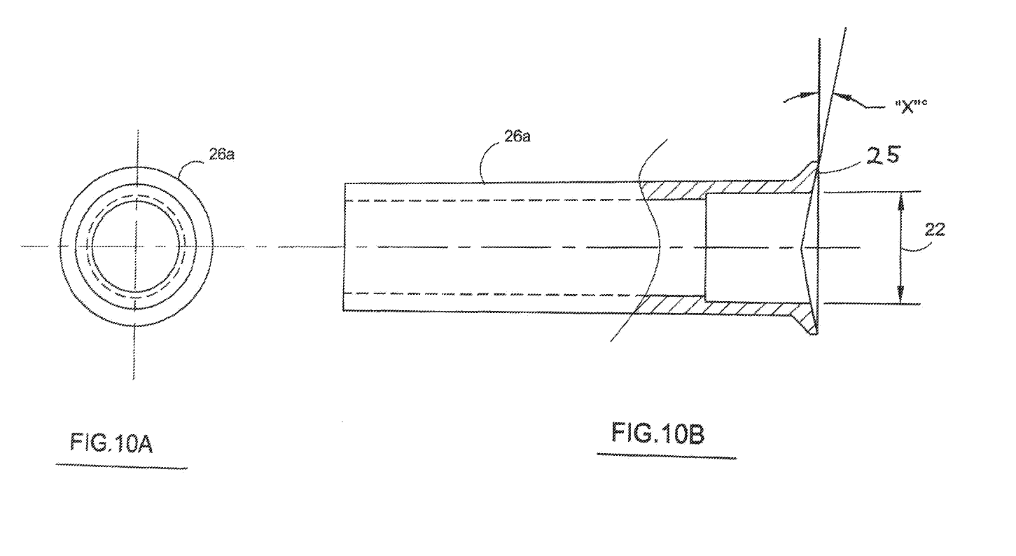

In one embodiment, surface 25 of either cup seal 26A and 26B is angularly flared towards suction cup 16. This cup seal angular flare, shown in FIG. 10B as dimension X, provides support for suction cup 16 when holding and installing light bulb 30. In one embodiment, dimension X, being cup seal angular flare is between about 5-20 degrees.

In one embodiment, Solenoid valve 14 is electrically actuated. In another embodiment, solenoid valve 14 is mechanically actuated.

In one embodiment, a user will position light bowl 30 on two suction cups 16 and apply pressure until suction cup 16 grasps the outer surface of light bulb 30. Once like bold Bertie is in position a user will attach light bulb 30 to a socket by rotating the entirety of assembly 10. Once light bulb furry is completely installed, a user will then desire to release suction cups 16 from lightbulb 30.

According to the present invention, the desired release is accomplished through various embodiments.

In one embodiment, a string or other extending member is connected to tab 16a. The user will pull the string in the direction away from the first end of assembly 10, being the end with suction cup 16 and towards the second end of assembly 10, being the end with handle 18.

The tab will lift an edge of suction cup 16, allow air to enter the space between suction cup 16 and light bulb 30 and subsequently release the suction imparted by suction cup 16 onto light bulb 30. Once this suction is released, the light bulb detaches.

In another embodiment, solenoid valve 14 inserts air into the space between suction cup 16 and light bulb 30. Once they air is inserted into the space the suction is released and the light bulb detaches.

As stated above solenoid 14 is selectively an electrically operated solenoid or a mechanical solenoid.

In one embodiment, when an electrically actuated solenoid valve 14 is utilized, a transistor is positioned between the battery and the solenoid such that resistance due to wire length is negated. In this embodiment, this is an important feature because internal wiring in one embodiment is coiled to provide for length differentials when pole support 20 is constructed and arranged as a telescoping pole.

What is claimed is:

1. An apparatus for connecting and disconnecting light bulbs, said apparatus comprising:
a suction cup having a mounting surface;
a suction cup support having an angularly flared surface adjacent to and in the direction of said suction cup; and
at least one structure constructed and arranged to introduce air to said mounting surface.

2. The apparatus of claim 1 wherein said structure constructed and arranged to introduce air to said mounting surface is a release tab.

3. The apparatus of claim 1 wherein said structure constructed and arranged to introduce air to said mounting surface is an air channel operatively associated with a solenoid valve.

4. The apparatus of claim 3 wherein said solenoid valve is a mechanical, non-electric valve.

5. The apparatus of claim 3 wherein said solenoid valve is an electric valve.

6. The apparatus of claim 5 wherein said valve is actuated by an actuator with direct hard-wired connection.

7. The apparatus of claim 5 wherein said valve is actuated by an actuator with a wireless connection.

8. The apparatus of claim 1 wherein said cup support is constructed and arranges as two congruent half circles that snap fit into a support base.

9. The apparatus of claim 1 further comprising a support pole.

10. The apparatus of claim 9 wherein said support pole is constructed and arranged as a telescoping pole.

11. The apparatus of claim 1 wherein said angular flare is between about 5-20 degrees.

12. A method of installing a light bulb, said method comprising the steps of:
providing an apparatus according to claim 1;
providing a light bulb to be installed in a light bulb socket;
positioning said light bulb onto said mounting surface;
applying pressure from said light bulb in a direction of said mounting surface;
imparting suction upon said light bulb from said applying of pressure;
positioning said light bulb for installation into said light bulb socket;
rotating said assembly in a manner such that said light bulb mates with said light bulb socket; and
introducing air to said suction cup mounting surface by activating said structure constructed and arranged to introduce air to said mounting surface.

13. The method of claim 12 further comprising providing said suction cup with at least one release tab positioned along a perimeter edge.

14. The method of claim 12 further comprising applying pressure on said release tab in a direction away from said light bulb.

15. The method of claim 12 further comprising providing a solenoid valve and an air delivery channel, whereby said air delivery channel is configured to deliver air to said mounting surface.

16. The method of claim 15 wherein said solenoid valve is a mechanical non-electric valve.

17. The method of claim 15 wherein said solenoid valve is an electric valve.
